(19) United States
(12) Patent Application Publication
(10) Pub. No.: US 2008/0301261 A1
(43) Pub. Date: Dec. 4, 2008

(54) DATA FILE EDIT SYSTEM, STORAGE MEDIUM, PROCESS SERVER, AND USER CLIENT

(75) Inventor: Shinsuke NAKAZAWA, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 12/033,930

(22) Filed: Feb. 20, 2008

(30) Foreign Application Priority Data
May 30, 2007 (JP) 2007-143022

(51) Int. Cl. G06F 15/16

(52) U.S. Cl. 709/219

(57) ABSTRACT

A process server is included in a data file edit system together with a file storage unit that stores a data file to be shared so as to be accessed only from a client, a provider client and a user client, and comprises an edit request receiving unit that receives an edit request; a generation unit that generates edit process attribute information which contains process identifying information of an edit process to be carried out in response to the edit request and its own server identifying information; an attribute information transmitting unit that transmits the edit process attribute information to the provider client having transmitted the edit request; and an editing unit that carries out an edit process specified by the edit instruction information, on a data file stored in the file information memory, and storing edited data generated in the edit process in an edited data memory.

### PRIORITY INFORMATION

This application is based on and claims priority under 35 USC 119 from Japanese Patent Application No. 2007-143022 filed May 30, 2007.

### BACKGROUND

1. Technical Field

The present invention relates to a data file edit system, a storage medium, a process server, and a user client.

2. Related Art

When a user wishes to process an electronic document in such a manner that imposes a large load on a computer, the client computer, if forced to do the processing, could not carry out other processing.

In an arrangement in which a server edits a data file so that the data file and the edited result are stored in a storage place, such as a file server or the like, to be shared by others, it is necessary to wait for the completion of the edit processing by the process server before the data file and the edited result are stored in the storage place in association with each other.

### SUMMARY

According to one aspect of the present invention, there is provided a data file edit system, including a file storage unit that stores a data file; a provider client that provides a data file to be stored in the file storage unit; a user client that uses the data file stored in the file storage unit; and a process server that carries out an edit process requested on the data file, wherein the provider client includes an edit request transmitting unit that transmits an edit request which contains an edit target data file and edit instruction information for the data file, to the process server, an edit process attribute information receiving unit that receives edit process attribute information transmitted from the process server in response to the edit request transmitted from the edit request transmitting unit, and a file registration unit that registers the edit target data file and the edit process attribute information associated with the data file, in the file storage unit, the process server includes an edit request receiving unit that receives the edit request transmitted from the provider client, a file information memory that stores the data file contained in the edit request received by the edit request receiving unit, a generation unit that generates the edit process attribute information which contains process identifying information associated with the edit process to be carried out in response to the edit request received by the edit request receiving unit, an attribute information transmitting unit that transmits the edit process attribute information generated by the generation unit to the provider client having transmitted the edit request, an edit process execution unit that carries out an edit process specified by the edit instruction information contained in the edit request, on the data file stored in the file information memory, an edited data memory that stores edited data generated in the edit process carried out by the edit process execution unit, a transmission request receiving unit that receives an edited data transmission request transmitted from the user client, and an edited data transmitting unit that reads the edited data from the edited data memory, the edited data generated in an edit process specified by the process identifying information contained in the edited data transmission request, received by the transmission request receiving unit, and transmits to the user client having transmitted the edited data transmission request, and the user client includes an acquiring unit that acquires the data file and the edit process attribute information associated with that data file, a transmission request transmitting unit that transmits the edited data transmission request which contains the process identifying information acquired by the acquiring unit to the process server, and an edited data receiving unit that receives the edited data transmitted from the process server in response to the edited data transmission request transmitted from the transmission request transmitting unit.

### BRIEF DESCRIPTION OF THE DRAWINGS

Exemplary embodiments the present invention will be described in detail based on the following figures, wherein:

FIG. 1 is a diagram showing a complete structure of a data file edit system according to one exemplary embodiment of the present invention;

FIG. 2 is a diagram showing hardware structure of respective computers in this exemplary embodiment;

FIG. 3 is a block diagram showing a structure of the data file edit system in this exemplary embodiment;

FIG. 4 is a flowchart of a process carried out in a provider client in the exemplary embodiment;

FIG. 5 is a flowchart of a process carried out in a process server in the exemplary embodiment;

FIG. 6 is a flowchart of a process upon receipt of an edit request shown in FIG. 5;

FIG. 7 is a diagram showing an example structure of data registered in a common document memory in the exemplary embodiment;

FIG. 8 is a flowchart of a process upon receipt of an edited data transmission request shown in FIG. 5;

FIG. 9 is a flowchart of a process carried out in a user client in the exemplary embodiment; and

FIG. 10 is a flowchart of a process upon receipt of a post-edit process request shown in FIG. 5.

### DETAILED DESCRIPTION

In the following, an exemplary embodiment of the present invention will be described based on the following drawings.

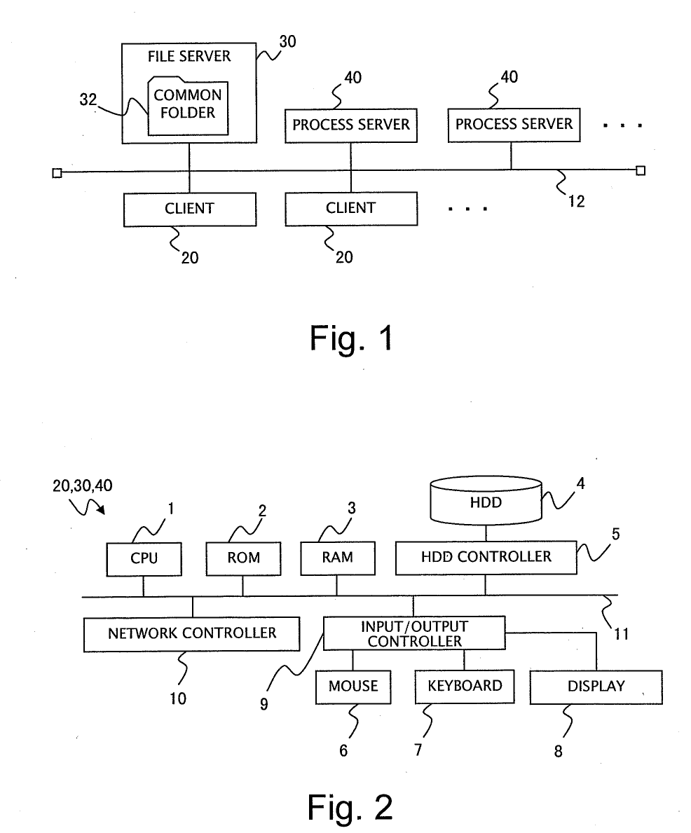

FIG. 1 is a diagram showing a complete structure of one exemplary embodiment of a data file edit system according to the present invention. FIG. 1 shows a structure in which plural clients 20, a file server 30, and plural process servers 40 are connected to one another via a network 12. The file server 30 is a computer storing a data file provided by a user. The client 20 is a computer for use by a provider of an electronic document, or a data file format, or a user of an electronic document provided by a provider. A single client 20 may serve as a provider client when the user thereof provides an electronic document and also as a user client when the user thereof uses an electronic document provided by another user. In consideration of security, the file server 30 may allow only the client 20, but not the process server 40, to access a data file registered in the common folder 32.

It should be noted that although the network 12 is formed using a LAN (Local Area Network) in FIG. 1, this is not an exclusive example, and any other structure which enables data exchange between the client 20 and the file server 30 and the process server 40 is applicable.

FIG. 2 is a diagram showing a hardware structure of each computer in this exemplary embodiment. The hardware structure of any computers 20, 30, 40 shown in FIG. 1, which can be realized using a general purpose computer, despite possible difference in performance, can be expressed as shown in FIG. 2.

As shown in FIG. 2, the computers 20, 30, 40 each comprise a CPU 1, a ROM 2, a RAM 3, a HDD controller 5 connected to a hard disk drive (HDD) 4, an input/output controller 9 connecting to a mouse 6 and a keyboard 7, both serving as input means, and also to a display 8 serving as a display device, and a network controller 10 serving as a communication means, all connected to an internal bus 11.

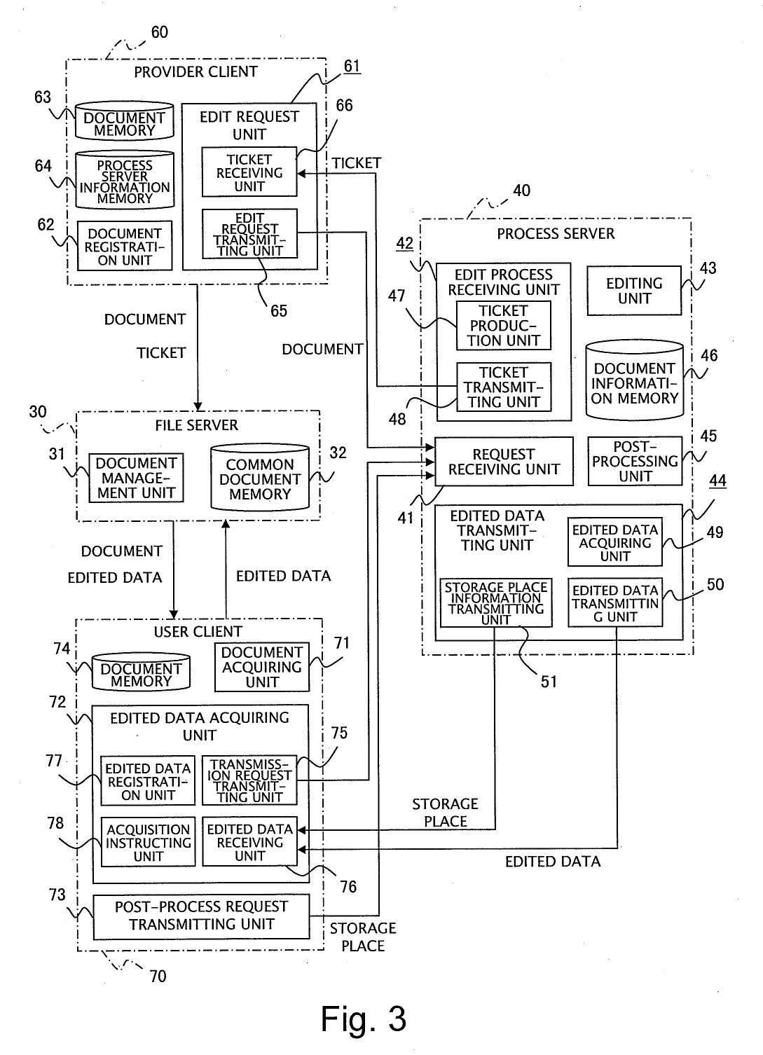

FIG. 3 is a block diagram showing a structure of a data file edit system in the exemplary embodiment. In FIG. 3, a client 20 serving as a provider client 60 and a client 20 serving as a user client 70 are shown separately as the client 20 serving as a provider client 60 and the client 20 serving as a user client 70 use different functions. As it is adapted to be uses as either a provider client 60 or a user client 70, a single client 20 has all functions necessary for both purposes, though a client 20 having an exclusive use may have only the functions necessary for that use. FIG. 3 shows only one process server 40 as all process servers 40 connected to the network 12 have the same functional blocks. It should be noted that FIG. 3 shows only the functional blocks necessary in rendering the exemplary embodiment into practice, with other general purpose functions inherent to a computer omitted.

In FIG. 3, the provider client 60 comprises an edit request unit 61, a document registration unit 62, a document memory 63, and a process server information memory 64. The edit request unit 61 sends an edit request to the process server 40 to request the process server 40 to edit an electronic document which the provider client 60 provides. The edit request unit 61 includes an edit request transmitting unit 65 and a ticket receiving unit 66. The edit request transmitting unit 65 sends an edit request to the process server 40, and the ticket receiving unit 66 receives a ticket which the process server 40 sends in response to the edit request from the edit request transmitting unit 65. The document memory 63 stores an electronic document to be shared by another user and to be edited. The document registration unit 62 attaches the ticket received by the ticket receiving unit 66 to an electronic document to be shared, stored in the document memory 63, before registering in the file server 30. The process server information memory 64 stores information, such as performance, specifications, an application available, and so forth, about a process server 40 available to be a potential request destination.

The structural elements 61, 62 of the provider client 60 are realized in cooperation with a computer serving as the client 60 and a program executed by the CPU 1 mounted in the computer. The memories 63, 64 are realized using a HDD 4 mounted in the provider client 60.

The process server 40 comprises a request receiving unit 41, an edit process receiving unit 42, an editing unit 43, an edited data transmitting unit 44, a post-processing unit 45, and a document information memory 46. The request receiving unit 41 receives various requests from the clients 60, 70. The edit process receiving unit 42 begins operating upon receipt of an edit request by the request receiving unit 41, then determines whether or not its own server is capable of the designated edit process, and instructs the editing unit 43 to begin editing, and so forth. The edit process receiving unit 42 includes a ticket production unit 47 for producing a ticket upon receipt of an edit request. It should be noted that a ticket is edit process attribute information which contains process identifying information (hereinafter referred to as a “process ID”) for identifying an edit process to be carried out in response to an edit request, and server identifying information (hereinafter referred to as a “server ID”) for identifying its own server, which carries out edit processing in response to an edit request. A ticket transmitting unit 48 sends a ticket produced by the ticket production unit 47 to a provider client 60 having sent the edit request.

The editing unit 43 carries out an edit process designated by the edit request according to an instruction from the edit process receiving unit 42. The edited data transmitting unit 44 begins operating upon receipt of an edited data transmission request by the request receiving unit 41. The edited data transmitting unit 44 includes an edited data acquiring unit 49, an edited data transmitting unit 50, and a storage place information transmitting unit 51. The edited data acquiring unit 49 reads edited data to be transmitted from the document information memory 46, where the edited data produced by the editing unit 43 in edit processing is stored in association with the concerned electronic document. The edited data transmitting unit 50 sends the read edited data to the user client 70 having sent the edited data transmission request.

The storage place information transmitting unit 51 sends storage place information to the user client 70 having sent the edited data transmission request, the storage place information being registered in the document information memory 46, instead of edited data, with the edited data produced in edit processing all already transmitted by the edited data transmitting unit 50. The post-processing unit 45 begins operating upon receipt of a post-edit process request by the request receiving unit 41, and deletes the electronic document to be edited and the edited data produced in the edit process identified by the process ID contained in the post-edit process request from the document information memory 46. Further, the post-processing unit 45 registers the storage place information of the electronic document, contained in the post-edit process request, in the document information memory 46 so as to be associated with the process ID.

The structural elements 41 to 45 in the process server 40 are realized in cooperation with a computer serving as the process server 40 and a program to be executed by the CPU 1 mounted in the process server 40. The document information memory 46 is realized using a HDD 4 mounted in the process server 40.

The user client 70 comprises a document acquiring unit 71, an edited data acquiring unit 72, a post-process request transmitting unit 73, and a document memory 74. The document memory 74 stores an electronic document among those acquired by the user from the file server 30, which the user wishes to keep in the user client 70. The document acquiring unit 71 acquires a desired electronic document from the file server 30 or the document memory 74. The edited data acquiring unit 72 acquires a result, that is, edited data, obtained by editing the electronic document acquired by the document acquiring unit 71 from the process server 40. The edited data acquiring unit 72 includes a transmission request transmitting unit 75, an edited data receiving unit 76, an edited data registration unit 77, and an acquisition instructing unit 78.

The transmission request transmitting unit 75 sends an edited data transmission request containing a process ID contained in the ticket attached to an electronic document to the process server 40 identified by the server ID also contained in the ticket. The edited data receiving unit 76 receives the edited data sent from the process server 40 in response to an edited data transmission request sent from the transmission request transmitting unit 75. The edited data registration unit 77 registers the edited data received by the edited data receiving unit 76, in the file server 30. In the case where the edited data receiving unit 76 receives the storage place information of an electronic document, instead of the edited data, the acquisition instructing unit 78 instructs the document acquiring unit 71 to acquire an electronic document from the storage place specified by the storage place information.

Upon completion of the editing of the electronic document and with detection that the resultant edited data is all registered in the file server 30, the post-process request transmitting unit 73 deletes the ticket attached to the electronic document from the file server 30, and sends a post-edit process request containing the process ID containing in the ticket and the storage place information specifying the storage place of the electronic document, to the process server 40 identified by the server ID contained in the ticket.

The structural elements 71 to 73 of the user client 70 are realized in cooperation with a computer serving as the user client 70 and a program executed by the CPU 1 mounted in the user client 70. The document information memory 46 is realized using a HDD 4 mounted in the user client 70.

The file server 30 comprises a document management unit 31 and a common document memory 32. The common document memory 32 stores an electronic document provided by a document provider. According to an instruction from the client 60, 70, the document management unit 31 manages the data stored in the common document memory 32, the management including registration of an electronic document and the edited data in the common document memory 32, data reading, date deletion when necessary, and so forth. In consideration of security, the document management unit 31 may allow only the clients 60, 70, but not the process server 40, to access the common document memory 32.

The document management unit 31 of the file server 30 is realized in cooperation with a computer serving as the file server 30 and a program executed by the CPU 1 mounted in the file server 30. The common document memory 32 is realized using a HDD 4 mounted in the file server 30.

A program used in this exemplary embodiment may be provided via a communication means or being stored in a computer readable recording medium, such as a CD-ROM, a DVD-ROM, and so forth. A program provided via a communication means or a recording medium is installed into any of the computers 20, 30, 40, and the CPU 1 of that computer 20, 30, 40 sequentially executes the install program, whereby various processes are carried out.

In the following, an operation in this exemplary embodiment will be described. The exemplary embodiment can be roughly divided into a process to request the process server 40 to edit an electronic document when registering the electronic document in the file server 30 and a process to acquire edited data when wishing to use an electronic data registered in the file server 30, the acquiring process carried out separately from the process to use the electronic document.

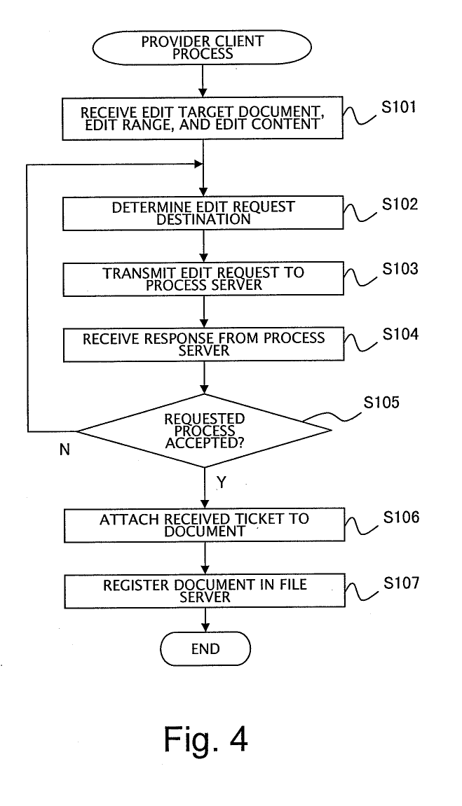

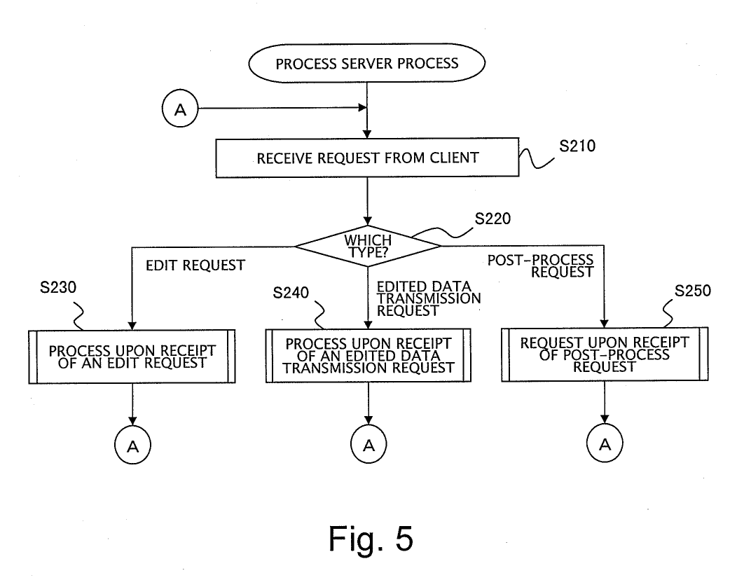

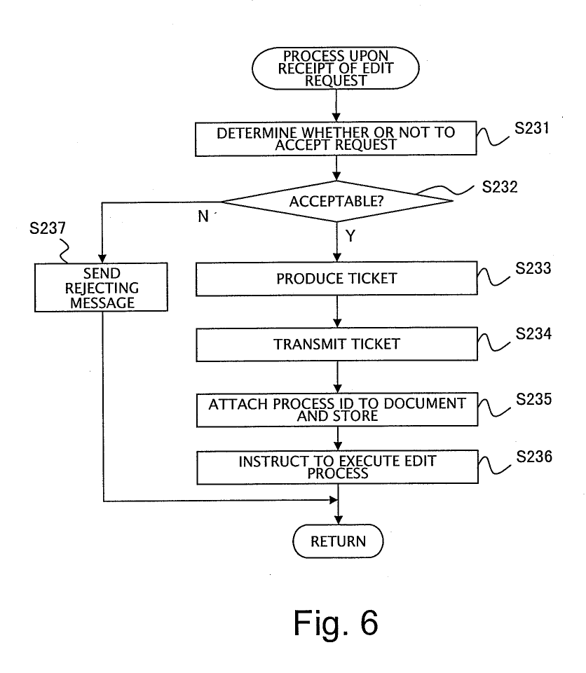

FIG. 4 is a flowchart of a process to be carried out by the provider client 60 in this exemplary embodiment; FIG. 5 is a flowchart of a process to be carried out by the process server 40 in this exemplary embodiment; and FIG. 6 is a flowchart of a process to be carried out when an edit request is received from the provider client 60 among those to be carried out by the process server 40 in this exemplary embodiment. Initially, a process to request the process server 40 to edit an electronic document when registering the electronic document in the file server 30 will be described with reference to the flowchart.

The user of the provider client 60, or the provider of a document, arranges to display the file name of the electronic document data (hereinafter simply referred to as a “document”) stored in the document memory 63 on the display 8, and selects a document which the user wishes to share with other users and to request the process server 40 to edit from among those of which names are displayed. A user wishing to request editing of only a part of a document, rather than the entire document, designates a range for editing (an edit target range), which is achieved by displaying the content of the document on the screen, utilizing a document application, and designating a desired range, utilizing an existing document application function. It should be noted that the entire document is designated as an edit target range in the following description. In addition, the user designates the content of an edit process which the user wishes to request the process server 40 to carry out. It is assumed here that the user designates a character recognition process utilizing an OCR (optical character recognition) function available with the process server 40 as the edit process.

With an edit target document or range, in some cases, and an edit process, all designated by the user as described above, the edit request unit 61 accepts the designation (step 101), and compares information, such as specifications, an available application, and so forth, about the process server 40, stored in the process server information memory 64, and the content of the user's designation to determine which process server 40 to request to carry out the edit process (step 102). Various methods are available for use as a reference in selection of one process server 40 to request from among plural process servers 40. For example, a process load may be calculated based on the content (a character recognition process in this example), amount, and so forth, of the edit process, and specify a process server 40 capable of tolerating the load and capable of the edit process. In order to cope with a case in which two or more such process servers 40 are available, the process server 40 may be given a priority order in advance, or a selection rule may be determined in advance, such that a process server 40 may be selected with constant frequencies while referring to the selection history. Obviously, availability of an application capable of the requested edit process is indispensable in the selection. It should be noted that the provider client 60 itself may carry out an edit process, depending on a process load, without requesting any process server 40, though it is determined here that any process server 40 is requested to edit.

With specification of a process server 40 to request (a request destination), the edit request transmitting unit 65 produces edit instruction information which contains the content of an edit process to request and a request type (an edit process here), and sends an edit request which contains the target document and the edit instruction information to the process server 40 determined as the request destination (step 103).

In the process server 40, the request receiving unit 41, which remains in a awaiting reception state, receives the edit request from the provider client 60 (step 210), and, knowing that the received request is an edit request with reference to the request type contained in the received request, instructs the edit process receiving unit 42 to begin operating, and supplies the received data. Thereafter, a process upon receipt of an edit request is carried out as follows (step 220, 230), which is described below with reference to FIG. 6.

Initially, the edit process receiving unit 42 determines whether or not its own server is capable of the requested edit process while referring to the data received from the request receiving unit 41, specifically, the document contained and the edit process content designated in the edit request (step 231). The determination is made in a similar manner to that in step 102, with additional reference to the current process load, and so forth. When it is determined that its own server can handle the request, that is, to accept the request (Y in step 232), the ticket production unit 47 in the edit process receiving unit 42 produces edit process attribute information, or a ticket, which contains its own server ID and a process ID identifying an edit process to be carried out in response to the received edit request (step 233). It should be noted that the process ID is information identifying the received request or a job in which the received edit process is carried out, rather than, for example, a character recognition process among various edit processes. The server ID is information, such as a URL, which can specify a transmission destination to which the user client 70 sends an edited data transmission request or the like, with details thereof to be described later. With the ticket produced, the ticket transmitting unit 48 sends the ticket to the provider client 60 having sent the edit request (step 234).

Also, upon receipt of a request from the provider client 60, as described above, the edit process receiving unit 42 attaches the process ID to be contained in the ticket to the received document, and stores in the document information memory 46 (step 235). Then, the edit process receiving unit 42 forwards the edit instruction information to the editing unit 43 to instruct to carry out the edit process (step 236), upon which the editing unit 43 reads the document specified by the process ID from the document information memory 46, and begins a character recognition process for the process range specified by the edit instruction information.

In the process server 40, when the process upon receipt of an edit request is completed as requested, the request receiving unit 41 shifts to an awaiting request reception state, and the editing unit 43 independently continues the character recognition process, as requested, to be completed while accumulating the processed result as edited data in the document information memory 46. As a character recognition process is generally carried out for every page, every time the process is completed for one page, edited data for that page is written in the document information memory 46 so as to be associated with the document page data.

Meanwhile, when it is determined in S232 that the request is not accepted due to the server's inability to accomplish the requested process or the like (N in step 232), the edit process receiving unit 42 sends a message rejecting the request, instead of a ticket, to the provider client 60 having sent the edit request (step 237).

When the process upon receipt of an edit request is completed, the request receiving unit 41 in the process server 40 shifts to an awaiting request reception state (step 210).

In the provider client 60, which is then waiting for a response after the transmission of the edit request, the ticket receiving unit 66 receives the ticket, or a response, from the process server 40, or the request destination (step 104). With a rejecting message received, instead of a ticket, that is, on understanding that the requested process server 40 does not accept the edit processing request (N in step 105), the edit request unit 61 repeats the selection of a process server 40 to request by determining another process server 40 as a request destination (step 102), and carries out the process in steps 103 and 104 to determine the process server 40 to request, with the description thereof not repeated here.

Meanwhile, when a ticket is received by the ticket receiving unit 66 (Y in step 105), the document registration unit 62 attaches the ticket to the document to register (step 106), and registers in the file server 30 (step 107). It should be noted that although it is arranged in the above exemplary embodiment such that the process server 40 sends a ticket to the provider client 60 and the provider client 60 attaches the ticket to the document, the process server 40 may attach the ticket to the document and send the document having the ticket attached thereto to the provider client 60. The document management unit 31 in the file server 30 stores the received document in a common folder in the common document memory 32, which is designated by the document provider.

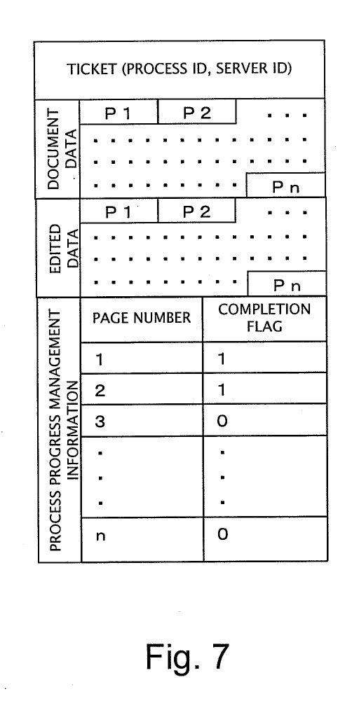

In the following, a structure of data stored in the common document memory 32 will be described with reference to FIG. 7.

FIG. 7 is a diagram showing an example of a data structure with a document registered in the common document memory 32 in this exemplary embodiment. The data registered has a document data area for storing the document, an area for storing the ticket attached to the document, an area for storing the edited data, and an area for storing process progress management information, all associated with one another. The edited data is produced by the process server 40 by carrying out edit processing, and obtained from the process server 40, using a method to be described later. The process progress management information is flag information to be referred to in determining whether or not the edited data of each page is already acquired from the process server 40 and used in managing the presence/absence of edited data for every page. In this exemplary embodiment, the progress of a process to acquire the edit data of each page is managed using a completion flag, in which a completion flag 1 indicates a page with edited data thereof completely acquired and a completion flag 0 indicates a page with edited data thereof yet to be acquired.

In the example shown in FIG. 7, it is known that the edited data of the first and second pages of the document data is already acquired from the process server 40. It should be noted that the flag value is not limited to the above-described example, and that the process progress management information is not even limited to flag information and may include any information which enables management of the presence/absence of edited data of each page.

The process progress management information is used to manage the presence/absence of edited data in units of edit process. That is, in this exemplary embodiment, in which a character recognition process is carried out for every page, a completion flag is provided for each page. However, in an edit process, for example, to combine two documents into one document, a single completion flag is provided for one resultant combined document as edited data first becomes available when the process to combine the documents is completed, and included in the process progress management information. In short, a completion flag to manage the presence/absence of edited data is provided in units of edit processes.

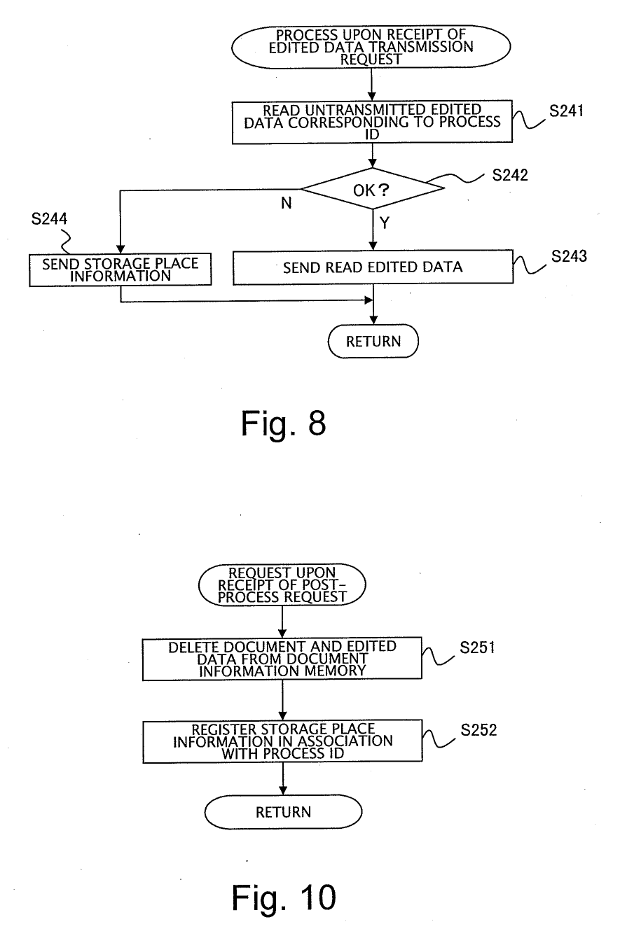

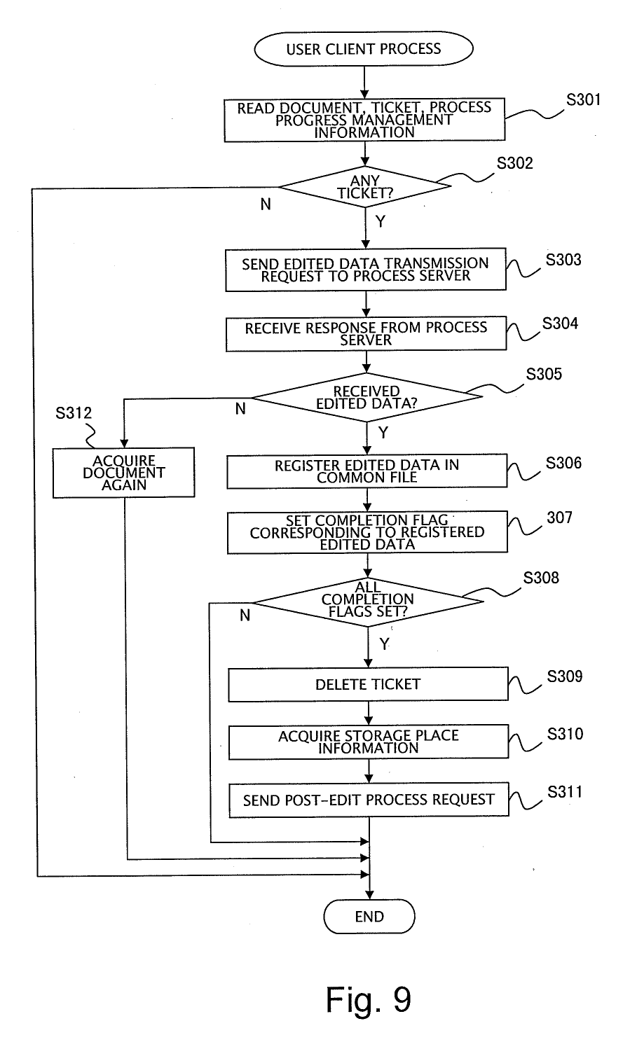

When the process to request the process server 40 to edit a document when registering the document in the file server 30 is completed, as described above, a process to use the commonly usable document stored in the file server 30 begins. FIG. 8 is a flowchart of a process to be carried out upon receipt of an edited data transmission request from the user client 70, among those to be carried out in the process server 40. FIG. 9 is a flowchart of a process to be carried out by the user client 70 in this exemplary embodiment. In the following, a process to be carried out when using a document registered in the file server 30, which is carried out separately from the process to use the document, will be described with reference to the flowchart shown in FIGS. 5, 8, and 9.

Specifically, the user of the user client 70 wishing to use a document selects a document they wish to use from among those stored in the file server 30 or the document memory 74 and opens the document, utilizing a predetermined document application, which is achieved by displaying the file names of the documents stored in the common file 32 on the display 8 and selecting one from those shown. It is assumed here that a document stored in the file server 30 is selected. The document user carries out their desired edit process within a permitted range for the document whose name is shown on the display 8.

That is, the edited data acquiring unit 72 carries out the following process as well as the document process carried out by the document user. Specifically, when reading the document selected by the document user from the file server 30, the edited data acquiring unit 72 reads the ticket and the process progress management information, both attached to the selected document (step 301). In the case where no ticket is read as no ticket is attached to the document (N in step 302), it is determined that the edited data for all pages of the document is already stored in the file server 30, and the process is terminated. That is, the document user, who continues the document process as well as the process carried out by the edited data acquiring unit 72, can refer to the document and the edited data for all pages of the document.

Meanwhile, when the ticket can be read (Y in step 302), the transmission request transmitting unit 75 produces an edited data transmission request containing the process ID contained in the ticket, untransmitted page information, and a request type (edited data acquisition, here), and sends the edited data transmission request to the process server 40 (step 303), which can be identified by the server ID contained in the ticket.

The untransmitted page information contains the top page of the edited data to be acquired. The edited data having been acquired thus far from the process server 40 may be identified with reference to the completion flag, or the process progress management information. That is, when the edited data up to page m (0<=m<n) of the document having n pages has been acquired, inclusion of untransmitted page information of page (m+1) in the edited data transmission request makes it possible to inform the process server 40 of the fact that the data for page (m+1) and subsequent pages is to be acquired and thus to request to transmit the data.

In the process server 40, the request receiving unit 41, which is in an awaiting reception state, receives the edited data transmission request from the user client 70 (step 210). Knowing, based on the request type contained in the received request, that the received request is an edited data transmission request, the request receiving unit 41 instructs the edited data transmitting unit 44 to begin operating, and supplies the received data. Thereafter, a process upon receipt of an edited data transmission request is carried out (steps 220, 240). This process will be described with reference to FIG. 8.

That is, when the edited data transmitting unit 44 begins operating upon receipt of the data sent from the request receiving unit 41, the edited data acquiring unit 49 in the edited data transmitting unit 44 reads the data produced in the edit process specified by the given data from the request receiving unit 41, specifically, the process ID contained in the edited data transmission request, from the document information memory 46 (step 241). In the above, as untransmitted page information is contained in the edited data transmission request, only the edited data for the page specified by the untransmitted page information and subsequent pages among the edited data produced by the editing unit 43 are read from the document information memory 46. In the above, in the case where the document editing by the editing unit 43 is already completed, the edited data up to the last page is read, which makes the current data transmission the last data transmission. Also, in the case where an edited data transmission request is sent after the edited data for all pages of the document is transmitted, no edited data is left to be read (N in step 242), with a process to be carried out in such a case to be described later. Once the edited data acquiring unit 49 acquires all edited data available for transmission, the edited data transmitting unit 50 forwards the edited data to the user client 70 having sent the edited data transmission request (step 243).

Here, it should be noted that the purpose of including the untransmitted page information in the edited data transmission request is to avoid retransmission of transmitted edited data by specifying the edited data to be transmitted. In view of the above, it may be alternatively arranged such that information equivalent to untransmitted page information is stored in the process server 40, instead of the arrangement in which untransmitted page information is prepared on the user client 70 side. Obviously, in a case free from the need to consider a network load, a transmission time, and so forth, transmitted edited data may be retransmitted. Alternatively, the edited data transmitted by the edited data transmitting unit 50 in step 243 may be deleted from the document information memory 46. This makes it possible to avoid retransmission of transmitted edited data, while eliminating the need to use untransmitted page information.

With the process upon receipt of an edited data transmission request completed, the request receiving unit 41 in the process server 40 shifts to an awaiting reception state (step 210).

In the user client 70, which is then waiting for a response after the transmission of the edited data transmission request, the edited data receiving unit 76 receives a response from the process server 40 of the request transmission destination (step 304). In the case where the edited data receiving unit 76 receives one or more edited data items as a response from the process server 40 (Y in step 305), the edited data registration unit 77 registers the received edited data in the file server 30 so as to be associated with the edit target document (step 306), and instructs to set a completion flag for the page corresponding to the edited data to be registered (step 307). The document management unit 31 in the file server 30 registers the received edited data in the common document memory 32 so as to be associated with the document data stored therein, and sets a completion flag for the page concerned according to the instruction.

It should be noted that the document user becomes an authenticated user by logging in the system, who is entitled to use a document stored in the common document memory 32, to register edited data to be attached to the document, and to access to set a completion flag.

When it is known by referring to the completion flag that the edited data for all pages of the document is yet to be acquired in the above described edited data acquiring process (N in step 308), the edited data acquiring process in connection with use of the document is completed.

The above-described edited data acquiring process is carried out every time any user uses a document. That is, the user client 70 acquires edited data produced thus far from the process server 40 and registers in the file server 30 every time that document is used. When the process server 40 completes editing of the document with edited data for all of the pages of the document produced and any user thereafter uses the document, the user client 70 acquires the edited data up to the last page from the process server 40.

It should be noted that it is possible that the edited data acquiring process to be carried out while a document is using, as described above, be carried out in parallel by plural document users. That is, plural sets of edited data acquiring processing may be carried out in parallel by plural users who use the same document at the same time. This may cause a possibility of conflict among attempts to acquire the same edited data from the process server 40. In order to avoid the above, the process server 40 may delete transmitted edited data. Alternatively, in an arrangement using a completion flag, access to the completion flag may be locked to thereby control such that the edited data acquiring process is exclusively carried out.

Returning to FIG. 9, when it is known that the edited data for all pages of the document is acquired with reference to the completion flag (Y in step 308), a post-edited data acquiring process is carried out as described below. FIG. 10 is a flowchart of a process to be carried out after the edited data for the entire document is registered in the file server 30, among those to be carried out in the process server 40. In the following, the post-process will be described with reference to FIGS. 9 and 10.

Specifically, knowing, with reference to the completion flag, that the edited data for all pages is already acquired (Y in step 308), the post-process request transmitting unit 73 deletes the ticket from the document stored in the file server 30 (step 309), obtains the storage place information about the document with the ticket deleted therefrom (step 310), and sends a post-edit process request which contains the storage place information, the process ID contained in the ticket, and a request type (a post-edit process here) to the process server 40 identified by the server ID contained in the ticket deleted (step 311).

In the process server 40, the request receiving unit 41, which is in a reception waiting state, receives the post-edit process request sent by the user client 70 (step 210), and, knowing from the request type contained in the received request that the received is a post-edit process request, instructs the post-processing unit 45 to begin operating and supplies the data received. Thereafter, a process upon receipt of a post-edit process request to be described below (steps 220, 250) begins. This process will be described with reference to FIG. 10.

The post-processing unit 45 begins operating upon receipt of the data from the request receiving unit 41, and deletes the edit target document in the edit process identified by the given data, specifically, the process ID contained in the post-edit process request and the edited data produced in that process from the document information memory 46 (step 251). Thereafter, the post-processing unit 45 registers the storage place information contained in the post-edit process request, instead of the data deleted, in the document information memory 46 so as to be associated with the process ID (step 252). With the above-described process upon receipt of a post-edit process request completed, the request receiving unit 41 in the process server 40 shifts to the request reception waiting state (step 210).

Should an edited data acquisition request be received from the user client 70, the process server 40 carries out the process upon receipt of an edited data transmission request (steps 210, 220, 240). However, in this case, the edited data acquiring unit 49 cannot acquire edited data corresponding to the process ID contained in the edited data acquisition request, but acquires only the storage place information (N in step 242). Therefore, the storage place information transmitting unit 51 sends the storage place information to the user client 70 having sent the edited data transmission request (step 244).

With the storage place information received as a response from the process server 40 (N in step 305), the edited data receiving unit 76 of the user client 70 having sent the edited data transmission request instructs the document acquiring unit 71 to acquire the document from the file server 30 (step 312). With the above, the document stored in the document memory 74 is updated by the latest document acquired from the file server 30. Consequently, the produced edited data and the document are both held in the user client 70.

It should be noted that, whereas the file server 30 is provided as a storage unit of a common document in this exemplary embodiment, any client 20, rather than the file server 30, may be provided as the storage unit of a common document, for example, as long as the document can be stored for common use by the respective clients 20.

It should be noted that, instead of an arrangement in which a document, or one example of a data file format, is directly edited to produce edited data and the edited data is attached to the document before being stored, as in this exemplary embodiment, the present invention is also applicable to a case in which information related to a target data file is edited to produce edited data and the produced edited data is attached to the document. Further, the present invention is applicable to a case in which data acquired in an information acquiring process or the like is attached to the document.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A data file edit system, comprising:
a file storage unit that stores a data file;
a provider client that provides a data file to be stored in the file storage unit;
a user client that uses the data file stored in the file storage unit; and
a process server that carries out an edit process requested on the data file,
wherein
the provider client comprises
an edit request transmitting unit that transmits an edit request which contains an edit target data file and edit instruction information for the data file, to the process server,
an edit process attribute information receiving unit that receives edit process attribute information transmitted from the process server in response to the edit request transmitted from the edit request transmitting unit, and
a file registration unit that registers the edit target data file and the edit process attribute information associated with the data file in the file storage unit,
the process server comprises
an edit request receiving unit that receives the edit request transmitted from the provider client,
a file information memory that stores the data file contained in the edit request received by the edit request receiving unit,
a generation unit that generates the edit process attribute information which contains process identifying information associated with the edit process to be carried out in response to the edit request received by the edit request receiving unit,
an attribute information transmitting unit that transmits the edit process attribute information generated by the generation unit to the provider client having transmitted the edit request,
an edit process execution unit that carries out an edit process specified by the edit instruction information contained in the edit request, on the data file stored in the file information memory,
an edited data memory that stores edited data generated in the edit process carried out by the edit process execution unit,
a transmission request receiving unit that receives an edited data transmission request transmitted from the user client, and
an edited data transmitting unit that reads the edited data from the edited data memory, the edited data generated in an edit process specified by the process identifying information contained in the edited data transmission request, received by the transmission request receiving unit, and transmits to the user client having transmitted the edited data transmission request, and
the user client comprises
an acquiring unit that acquires the data file and the edit process attribute information associated with the data file,
a transmission request transmitting unit that transmits the edited data transmission request which contains the process identifying information acquired by the acquiring unit to the process server, and
an edited data receiving unit that receives the edited data transmitted from the process server in response to the edited data transmission request transmitted from the transmission request transmitting unit.

2. The data file edit system according to claim 1, wherein the user client further comprises an edited data registration unit that registers the edited data received by the edited data receiving unit in the file storage unit so as to be associated with the data file.

3. The data file edit system according to claim 1, wherein the user client further comprises a post-process request transmitting unit that transmits, after acquisition of all of the edited data generated in the edit process specified by the process identifying information contained in the edit process attribute information, a post-edit process request which contains the process identifying information and storage place information about all of the edited data to the process server,
the process server further comprises
a post-process request receiving unit that receives the post-edit process request transmitted from the user client,
a deletion unit that deletes the edited data generated in the edit process specified by the process identifying information contained in the post-edit process request from the edited data memory and the edit target data file from the file information memory,
a storage place information registration unit that registers the storage place information contained in the post-edit process request in the file information memory so as to be associated with the process identifying information, and
a storage place information transmitting unit that transmits, with the edited data generated in the edit process specified by the process identifying information contained in the edited data transmission request deleted by the deletion unit, the storage place information registered in the file information memory so as to be associated with the process identifying information to the user client having transmitted the edited data transmission request.

4. A storage medium storing a data file process program causing a process server that carries out a requested edit process on a data file, to carry out a process, the process server included in a data file edit system together with a file storage unit that stores a data file, a provider client that provides a data file to be stored in the file storage unit, and a user client that uses the data file stored in the file storage unit, the process comprising:
receiving an edit request transmitted from the provider client;
generating edit process attribute information which contains process identifying information associated with an edit process to be carried out in response to the edit request;
transmitting the edit process attribute information to the provider client having transmitted the edit request;
carrying out an edit process specified by edit instruction information contained in the edit request, on the data file stored in a file information memory that stores the data file contained in the edit request;
storing edited data generated in the edit process in an edited data memory;
receiving an edited data transmission request transmitted from the user client; and
reading the edited data from the edited data memory, the edited data generated in the edit process specified by the process identifying information contained in the edited data transmission request received, and transmitting to the user client having transmitted the edited data transmission request.

5. The storage medium according to claim 4, wherein the process further comprises
receiving a post-edit process request transmitted from the user client;
deleting edited data generated in an edit process specified by process identifying information contained in the post-edit process request from the edited data memory and an edit target data file from the file information memory;
registering file storage place information contained in the post-edit process request in the file information memory so as to be associated with the process identifying information; and
transmitting, with the edited data generated in the edit process specified by the process identifying information contained in the edited data transmission request deleted, the storage place information registered in the file information memory so as to be associated with the process identifying information, to the user client having transmitted the edited data transmission request.

6. A storage medium storing a data file use program causing a user client that uses a data file stored in a file storage unit, to carry out a process, the user client included in a data file edit system together with the file storage unit that stores a data file, a provider client that provides a data file to be stored in the file storage unit, a process server that carries out an edit process requested on the data file, the process comprising:
acquiring the data file;
retrieving process identifying information from edit process attribute information attached to the acquired data file, and transmitting an edited data transmission request which contains the process identifying information to the process server specified by server identifying information contained in the edit process attribute information; and
receiving edited data transmitted from the process server in response to the edited data transmission request.

7. The storage medium according to claim 6, wherein the process further comprising registering the edited data received in the file storage unit so as to be associated with the data file.

8. The storage medium according to claim 6, wherein the process further comprising transmitting, after acquisition of all of the edited data generated in the edit process specified by the process identifying information contained in the edit process attribute information, a post-edit process request, which contains the process identifying information and storage place information about all of the edited data, to the process server.

9. A process server included in a data file edit system together with a file storage unit that stores a data file for common use so as to be accessed only from a client, a provider client for use by a provider of the data file stored in the file storage unit, and a user client for use by a user using the data file stored in the file storage unit, comprising:
an edit request receiving unit that receives an edit request transmitted from the provider client;
a generation unit that generates edit process attribute information which contains process identifying information for identifying an edit process to be carried out in response to the edit request received by the edit request receiving unit and its own server identifying information;
an attribute information transmitting unit that transmits the edit process attribute information generated by the generation unit to the provider client having transmitted the edit request; and
an editing unit that carries out an edit process specified by the edit instruction information contained in the edit request, on a data file stored in the file information memory that stores the data file contained in the edit request received by the edit request receiving unit, and storing edited data generated in the edit process in an edited data memory.

10. A user client included in a data file edit system together with a file storage unit that stores a data file for common use so as to be accessed only from a client, a provider client for use by a provider of the data file stored in the file storage unit, and a process server that carries out an edit process requested on the data file, comprising:
an acquiring unit that acquires a data file;
a transmission request transmitting unit that retrieves process identifying information from edit process attribute information attached to the data file acquired by the acquiring unit, and transmitting an edited data transmission request which contains the process identifying information to the process server specified server identifying information contained in the process identifying information;
an edited data receiving unit that receives edited data transmitted from the process server in response to the edited data transmission request transmitted from the transmission request transmitting unit; and
an edited data registration unit that registers the edited data received by the edited data receiving unit in the file storage unit so as to be associated with the data file.
